(19) United States
(12) Patent Application Publication
(10) Pub. No.: US 2013/0169758 A1
(43) Pub. Date: Jul. 4, 2013

(54) THREE-DIMENSIONAL IMAGE GENERATING DEVICE

(71) Applicants: Chia-Ho Pan, Hsinchu City (TW); Ming-Jiun Liaw, Miaoli County (TW); Shuei-Lin Chen, Kaohsiung City (TW)

(72) Inventors: Chia-Ho Pan, Hsinchu City (TW); Ming-Jiun Liaw, Miaoli County (TW); Shuei-Lin Chen, Kaohsiung City (TW)

(73) Assignee: ALTEK CORPORATION, Hsinchu City (TW)

(21) Appl. No.: 13/411,646

(22) Filed: Mar. 5, 2012

(30) Foreign Application Priority Data
Dec. 28, 2011 (TW) 100149265

(51) Int. Cl. H04N 13/02; G06K 9/00

(52) U.S. Cl. 348/47; 382/154; 348/E13.074

(57) ABSTRACT

A three-dimensional (3D) image generating device including a first memory unit, a first (master) processor, and a second (slave) processor is provided. The first processor and the second processor respectively include a first image processing unit and a second image processing unit. The first processor further includes a data access unit. The first image processing unit and the second image processing unit respectively receive images representing a first human eye and a second human eye and generate a first image and a second image through image processing. The data access unit receives the first image from the first image processing unit and writes it into the first memory unit according to a predetermined 3D image format. The second image processed by the second image processing unit is transmitted to the data access unit and written into the first memory unit according to the predetermined 3D image format.

### CROSS-REFERENCE TO RELATED APPLICATION

This application claims the priority benefit of Taiwan application serial no. 100149265, filed Dec. 28, 2011. The entirety of the above-mentioned patent application is hereby incorporated by reference herein and made a part of this specification.

### BACKGROUND OF THE INVENTION

1. Field of the Invention

The invention generally relates to an image processing technique, and more particularly, to a three-dimensional (3D) image generating device.

2. Description of Related Art

Along with the development of technologies and image capturing techniques, many manufacturers have been devoted to the research and development of stereoscopic image capturing techniques in order to allow people to capture stereoscopic video images by themselves. FIG. 1 is a block diagram of a conventional three-dimensional (3D) digital camera 100. The digital camera 100 respectively captures a left-eye two-dimensional (2D) image and a right-eye 2D image by using two image sensors 110 and 112. The image processing unit 130 sequentially receives the left-eye 2D image and the right-eye 2D image through the transmission control unit 120, generates two processed 2D images through image processing, and simultaneously renders the two processed 2D images as a 3D image. If live view is desired, the image processing unit 130 transmits the 3D image to the display unit 160 through the display control unit 136. If 3D still images need to be stored, the image processing unit 130 stores the 3D images into the portable storage unit 170 (for example, a memory card) through the data transmission unit 134.

Because the digital camera 100 has only single image processing unit 130, the image processing unit 130 cannot process the left-eye 2D image and the right-eye 2D image simultaneously. Instead, the image processing unit 130 has to process 2D images in the sequence of “left, right, left, right, left, . . . ” through the transmission control unit 120. The other 2D image to be processed next needs to be temporarily stored into a memory. After processing both the left-eye 2D image and the right-eye 2D image, the single image processing unit 130 needs to integrate the two images according to a 3D image format. Thus, the digital camera 100 needs a buffer memory with sufficient capacity, and the image processing rate thereof is limited by the operation rate of the image processing unit 130. Besides, the transmission control unit 120 requires a different design in image transmission sequence therefore is difficult to implement.

Another 3D image capturing technique is disclosed in U.S. Patent No. US 2008151044A1, in which a stereoscopic camera simultaneously receives and processes a left-eye 2D image and a right-eye 2D image through two lenses and two image processing elements. Compared to the digital camera 100 in FIG. 1, the stereoscopic camera needs a larger buffer memory (and accordingly a larger chip area) for storing information of the left-eye 2D image and the right-eye 2D image since the image processing elements thereof stores the left-eye 2D image and the right-eye 2D image into the buffer memory via a system bus after performing simply a color conversion operation on the two images. Thus, this technique is suitable for a low-resolution (for example, lower than one megapixel) image system. As to a high-resolution image system, because a large memory is required inside the chip, the cost is very high and accordingly the technique described above is not applicable. On the other hand, because the 3D image integration operation is performed by an overall control section in the stereoscopic camera, a lot of image processing time is wasted on memory access and the processing process is slowed down. Thereby, through the two techniques described above, 3D image live view cannot be accomplished and a large buffer memory has to be adopted unnecessarily.

### SUMMARY OF THE INVENTION

Accordingly, the invention is directed to a three-dimensional (3D) image generating device. In the 3D image generating device, a left-eye 2D image and a right-eye 2D image are respectively processed by two processing units and then integrated into a 3D image. Thus, the 3D image generating device does not require a large-capacity buffer memory. Accordingly, the 3D image generating device offers low cost, good image processing efficiency, and increased 3D image integration rate.

According to a first embodiment of the invention, a 3D image generating device is provided, in which two processors and a single memory unit are adopted to provide live view of a 3D image. The 3D image generating device includes a first memory unit, a first (master) processor, and a second (slave) processor. The first memory unit stores 3D images. The first (master) processor includes a first image processing unit, a data access unit, a first command/data transmission interface, and a first task control unit. The first image processing unit receives a plurality of pixel data of a to-be-processed image representing a first human eye through an input terminal thereof and generates a plurality of image pixels of a first image through image processing. The data access unit is coupled to the first image processing unit and the first memory unit. The data access unit receives the image pixels of the first image from the first image processing unit and writes the image pixels to a corresponding storage address in the first memory unit according to a predetermined 3D image format. The first command/data transmission interface is coupled to the data access unit. The first task control unit issues commands and parameters to the first image processing unit, the data access unit, and the first command/data transmission interface to coordinate and execute operations of the first (master) processor.

The second (slave) processor is coupled to the first (master) processor, and the second (slave) processor includes a second image processing unit, a second command/data transmission interface, and a second task control unit. The second image processing unit receives a plurality of pixel data of a to-be-processed image representing a second human eye through an input terminal thereof and generates a plurality of image pixels of a second image through image processing. The second command/data transmission interface is coupled to the second image processing unit and the first command/data transmission interface of the first (master) processor. The first command/data transmission interface and the second command/data transmission interface transmit commands and data for the second (slave) processor and the first (master) processor. The second task control unit communicates with the first (master) processor through the second command/data transmission interface and issues commands to the second image processing unit, the data access unit, and the second command/data transmission interface to coordinate and execute operations of the second (slave) processor. The image pixels of the second image processed by the second image processing unit are transmitted to the first command/data transmission interface of the first (master) processor through the second command/data transmission interface and then to the data access unit in the first (master) processor, and the image pixels are written to a corresponding storage address in the first memory unit according to a predetermined 3D image format, so as to generate the 3D image.

According to a second embodiment of the invention, a 3D image generating device is provided, in which two image processing units and two memory units thereof are adopted to provide live view, still image storage, or video clipping of a 3D image. The 3D image generating device includes a first memory unit, a first (master) processor, a second memory unit, and a second (slave) processor. The first memory unit stores a plurality of or all pixel data of a first image representing a first human eye and stores the 3D image. The first (master) processor includes a first image processing unit, a first data access unit, a first command/data transmission interface, and a first task control unit. The first data access unit is coupled to the first memory unit and configured to access the first memory unit. The first image processing unit is coupled to the first data access unit. The first image processing unit reads the pixel data of the first image through the first data access unit, generates a plurality of image pixels of the first image through image processing, and writes the image pixels to a corresponding storage address in the first memory unit according to a predetermined 3D image format. The first command/data transmission interface is coupled to the first data access unit. The first task control unit issues commands to the first image processing unit, the first data access unit, and the first command/data transmission interface to coordinate and execute operations of the first (master) processor.

The second memory unit stores a plurality of or all pixel data of a second image representing a second human eye. The second (slave) processor includes a second data access unit, a second image processing unit, a second command/data transmission interface, and a second task control unit. The second data access unit is coupled to the second memory unit and configured to access the second memory unit. The second image processing unit is coupled to the second data access unit. The second image processing unit reads the pixel data of the second image through the second data access unit and generates a plurality of image pixels of the second image through image processing. The second command/data transmission interface is coupled to the second image processing unit and the first command/data transmission interface of the first (master) processor. The first command/data transmission interface and the second command/data transmission interface transmit data for the second (slave) processor and the first (master) processor. The second task control unit communicates with the first (master) processor through the second command/data transmission interface and issues commands to the second image processing unit, the second data access unit, and the second command/data transmission interface to coordinate and execute operations of the second (slave) processor.

The image pixels of the second image processed by the second image processing unit are transmitted to the first command/data transmission interface of the first (master) processor through the second command/data transmission interface and then to the first data access unit in the first (master) processor, and the image pixels of the second image are written to a corresponding storage address in the first memory unit according to a predetermined 3D image format, so as to generate the 3D image.

According to a third embodiment of the invention, a 3D image generating device is provided, in which two data access units and a single memory unit are adopted to respectively write pixel data to corresponding storage addresses in the memory unit according to a 3D image format and directly generate a 3D image in the memory unit, so as to provide still image storage or video clipping of the 3D image. The 3D image generating device includes a first memory unit, a first (master) processor, and a second (slave) processor. The first memory unit stores the 3D image. The first (master) processor includes a first image processing unit, a first data access unit, a first command/data transmission interface, and a first task control unit. Components of the first (master) processor are similar to those described in the first embodiment therefore will not be described herein.

The second (slave) processor is coupled to the first (master) processor. The second (slave) processor includes a second image processing unit, a second data access unit, a second command/data transmission interface, and a second task control unit. The difference between the second (slave) processor in the present embodiment and the second (slave) processors in the first and the second embodiment described above is that in the present embodiment, second data access unit of the second (slave) processor is coupled to the second image processing unit and the first memory unit. The second data access unit receives a plurality of image pixels of a second image processed by the second image processing unit and writes the image pixels to a corresponding storage address in the first memory unit according to a predetermined 3D image format, so as to generate the 3D image. Other components of the second (slave) processor are similar to those described in the first and the second embodiment therefore will not be described herein.

As described above, in a 3D image generating device provided by an embodiment of the invention, a left-eye 2D image and a right-eye 2D image are respectively processed by using two image processing units, and the two 2D images are integrated into a 3D image according to a predetermined 3D image format by using a primary processing unit or two data access units. Thereby, the 3D image generating device does not require a large-capacity buffer memory and accordingly it offers low cost, good image processing efficiency, and increased 3D image integration rate.

These and other exemplary embodiments, features, aspects, and advantages of the invention will be described and become more apparent from the detailed description of exemplary embodiments when read in conjunction with accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a conventional three-dimensional (3D) digital camera.

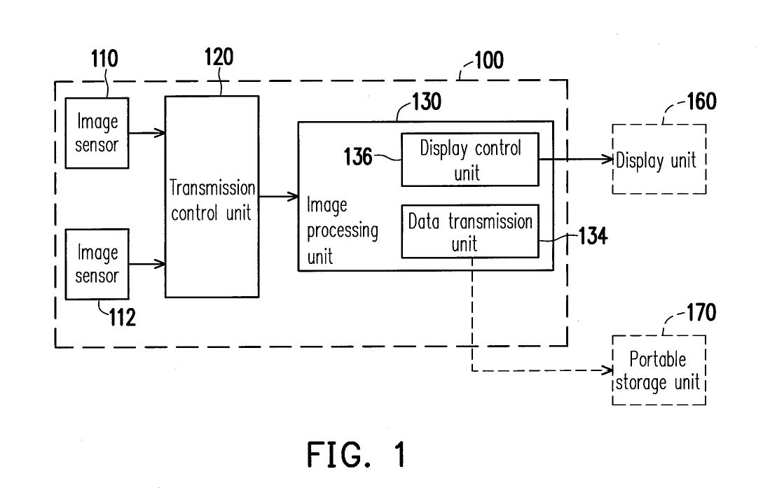

FIG. 2 is a function block diagram of a 3D image generating device and a 3D image capturing apparatus using the same according to a first embodiment of the invention.

FIG. 3 is a diagram illustrating the processing of an image stream at the generation, live view, and storage of a 3D image according to the first embodiment of the invention.

FIGS. 4A-4C are diagrams of three currently used 3D image formats.

FIG. 5 is a function block diagram of a 3D image generating device and a 3D image capturing apparatus using the same according to a second embodiment of the invention.

FIG. 6 is a diagram illustrating the processing of an image stream at the generation, live view, and storage of a 3D image according to the second embodiment of the invention.

FIG. 7 is a function block diagram of a 3D image generating device and a 3D image capturing apparatus using the same according to a third embodiment of the invention.

FIG. 8 is a diagram illustrating the processing of an image stream at the generation, live view, and storage of a 3D image according to the third embodiment of the invention.

### DESCRIPTION OF THE EMBODIMENTS

Reference will now be made in detail to the present preferred embodiments of the invention, examples of which are illustrated in the accompanying drawings.

Wherever possible, the same reference numbers are used in the drawings and the description to refer to the same or like parts.

### First Embodiment

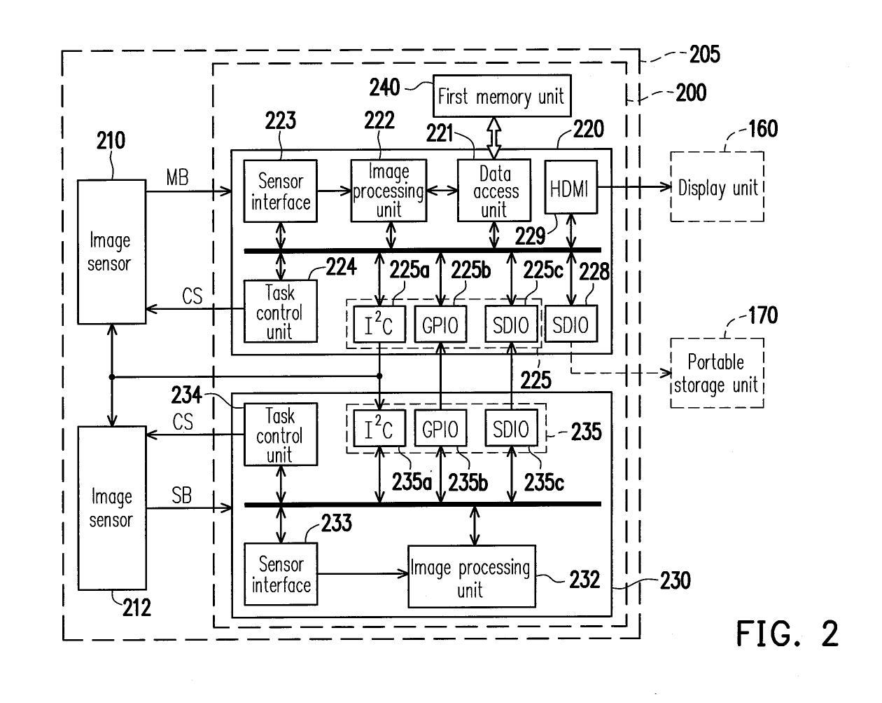

FIG. 2 is a function block diagram of a three-dimensional (3D) image generating device 200 and a 3D image capturing apparatus 205 using the same according to the first embodiment of the invention. The 3D image capturing apparatus 205 has two image sensors 210 and 212 and the 3D image generating device 200. The 3D image capturing apparatus 205 may be a digital camera, a video camera, or any other apparatus which can capture 3D images. However, the type of the 3D image capturing apparatus 205 in the present embodiment is not limited to foregoing examples.

The image sensors 210 and 212 in the present embodiment are implemented with CMOS image sensors (CIS) or charge couple device (CCD) image sensors. The first image sensor 210 is coupled to a first (master) processor 220 of the 3D image generating device 200 through an image bus MB. The first image sensor 210 captures a two-dimensional (2D) to-be-processed image representing a first human eye (for example, a right eye) and outputs the 2D to-be-processed image to the first (master) processor 220. Similarly, the second image sensor 212 is coupled to a second (slave) processor 230 of the 3D image generating device 200 through an image bus SB. The second image sensor 212 captures a 2D to-be-processed image representing a second human eye (for example, a left eye) and outputs the 2D to-be-processed image to the second (slave) processor 230. Herein the “to-be-processed images” refer to digital images output by the image sensors 210 and 212. Except that a gain may be multiplied and an offset may be deducted, no complicated calculation (for example, noise removal or image enhancement) is performed on the images, and the images are output substantially according to the arrangements of the color filters. For example, if the color filters of the image sensors 210 and 212 are arranged in a Bayer pattern and accordingly the ambient light is projected onto the photosensitive elements of the image sensors 210 and 212 in a colorful form, the 2D images sensed and output in the Bayer pattern are the “to-be-processed images” mentioned in the invention. The color filters of some other image sensors are not arranged in the Bayer pattern. However, in the invention, an output image is referred to as an “to-be-processed image” as long as the image keeps the arrangement of the color filter.

Referring to FIG. 2 again, the 3D image generating device 200 includes a first memory unit 240, the first (master) processor 220, and the second (slave) processor 230. In the present embodiment, the first memory unit 240 is implemented with a dynamic random access memory (DRAM). The first memory unit 240 is configured to store 3D images. The first (master) processor 220 and the second (slave) processor 230 may be application-specific integrated circuits (ASIC) used for image processing or field-programmable gate arrays (FPGA).

Below, the functions of various components of the first (master) processor 220 and the second (slave) processor 230 will be explained in detail. The first (master) processor 220 includes a first image processing unit 222, a first data access unit 221, a first command/data transmission interface 225, and a first task control unit 224. In the present embodiment, all of aforementioned components of the first (master) processor 220 use a first (master) bus for transmitting data. Herein the first command/data transmission interface 225 is implemented with a first command transmission interface (for example, an I²C interface 225a or a general purpose input/output (GPIO) interface 225b) and a first data transmission interface (for example, a secure digital input/.output (SDIO) interface 225c). The first command/data transmission interface 225 is coupled to the first data access unit 221.

The first (master) processor 220 further includes a sensor interface 223 coupled to the image sensor 210 and an external transmission interface. In the present embodiment, the external transmission interface may be a SDIO transmission interface 228 coupled to an external portable storage unit 170, a high definition multimedia interface (HDMI) 329, or both the SDIO transmission interface 228 and the HDMI 329.

While executing the image processing tasks in the present embodiment, the first task control unit 224 communicates with a second task control unit 234 of the second (slave) processor 230 through the first command/data transmission interface 225 according to the arranged sequence of the image processing tasks and issues commands and parameters to the first image processing unit 222, the first data access unit 221, and the first command/data transmission interface 225 in the first (master) processor 220 and even the image sensor 210 to coordinate and execute operations of the first (master) processor 220. On the other hand, the first data access unit 221 is coupled to the first image processing unit 222 and the first memory unit 240, and in the present embodiment, the first data access unit 221 is implemented with a DRAM controller.

In the present embodiment, the first task control unit 224 of the first (master) processor 220 issues related commands and parameters to the first image sensor 210 to control the operations of the first image sensor 210. In addition, the commands and parameters issued by the first task control unit 224 are also output to the second task control unit 234 of the second (slave) processor 230, so as to control the operations of the first image sensor 210 through the second task control unit 234. In other words, both the first image sensor 210 and the second image sensor 212 operate according to commands and parameters received from the first (master) processor 220. For example, in the present embodiment, the image capturing parameters and control commands of the image sensors 210 and 212 are controlled by using the I²C interface 232, so as to control the focal lengths, apertures, and transmission rates of the 2D images.

The second (slave) processor 230 is coupled to the first (master) processor 220. The second (slave) processor includes a second image processing unit 232, a second command/data transmission interface 235, and the second task control unit 234. The second (slave) processor 230 further includes a sensor interface 233 coupled to the image sensor 212. In the present embodiment, all of aforementioned components of the second (slave) processor 230 use a second (slave) bus for transmitting data.

The second command/data transmission interface 235 is implemented with a second command transmission interface (for example, an I²C interface 235a or a GPIO interface 235b) and a second data transmission interface (for example, a SDIO interface 235c). The first command/data transmission interface 225 and the second command/data transmission interface 235 are coupled with each other (for example, the I²C interface 225a is coupled to the I²C interface 235a, and the GPIO interface 225b is coupled to the GPIO interface 235b) so as to allow the first (master) processor 220 and the second (slave) processor 230 to communicate with each other. On the other hand, the first data transmission interface (the SDIO interface 225c) and the second data transmission interface (the SDIO interface 235c) are coupled with each other to transmit image data between the first (master) processor 220 and the second (slave) processor 230.

Similarly, while executing image processing tasks, the second task control unit 234 communicates with the first task control unit 224 of the first (master) processor 220 through the second command/data transmission interface 235 and issues commands and parameters to the second image processing unit 232, a second data access unit 231, and the second command/data transmission interface 235 of the second (slave) processor 230 and even the image sensor 212 to coordinate and execute operations of the second (slave) processor 230. In addition, the second command/data transmission interface 235 is coupled to the second image processing unit 232 and the first command/data transmission interface 225 of the first (master) processor 220. The first command/data transmission interface 225 and the second command/data transmission interface 235 transmit commands and data for the second (slave) processor 230 and the first (master) processor 220.

In the present embodiment, the first image processing unit 222 and the second image processing unit 232 further respectively include an image compression unit. The image compression units respectively compress and output a first image and a second image processed by the first image processing unit 222 and the second image processing unit 232. Thus, the file sizes of the first image and the second image processed by the first image processing unit 222 and the second image processing unit 232 can be greatly reduced.

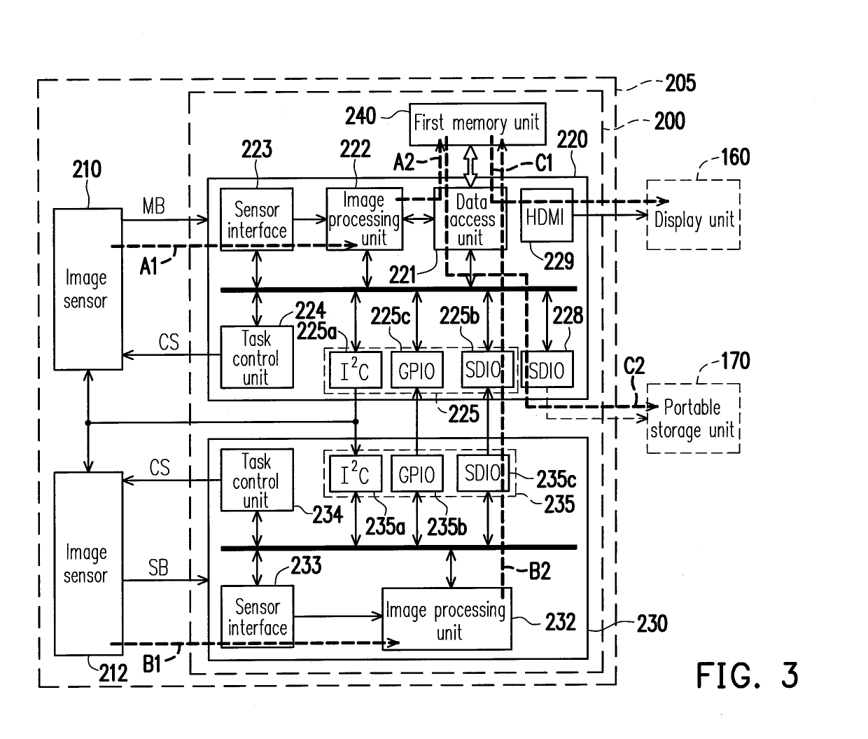

Below, the workflow of an image stream when the 3D image generating device 200 provides a live view will be described in detail. FIG. 3 is a diagram illustrating the processing of an image stream at the generation, live view, and storage of a 3D image according to the first embodiment of the invention. First, an input terminal of the first image processing unit 222 receives a plurality of pixel data of a to-be-processed image which represents a right human eye and is captured by the image sensor 210 through the sensor interface 223, as indicated by the dotted arrow A1. Then, the first image processing unit 222 performs an image processing on the to-be-processed image representing the right human eye in real time and generates a plurality of image pixels of the first image (a right-eye image) through the image processing.

Next, the first data access unit 221 receives the image pixels of the first image processed by the first image processing unit 222 and writes the image pixels of the first image to a storage address (as indicated by the dotted arrow A2) corresponding to the right human eye in the first memory unit 240 according to a predetermined 3D image format, wherein the 3D image format is presently frequently used.

When the operation indicated by the dotted arrow A1 is performed, the input terminal of the second image processing unit 232 further receives a plurality of pixel data of a to-be-processed image representing a left human eye at the same time, as indicated by the dotted arrow B1. Then, the second image processing unit 232 performs image processing on the to-be-processed image representing the left human eye in real time and generates a plurality of image pixels of the second image (a left-eye image) through the image processing.

Next, the image pixels of the second image processed by the second image processing unit 232 are transmitted to the SDIO interface 225c (i.e., the first data transmission interface in the first command/data transmission interface 225) of the first (master) processor 220 through the SDIO interface 235c (i.e., the second data transmission interface in the second command/data transmission interface 235) and then to the first data access unit 221 of the first (master) processor 220, as indicated by the dotted arrow B2. Thereafter, the first data access unit 221 writes the image pixels of the second image to a storage address corresponding to the left human eye in the first memory unit 240 according to a predetermined 3D image format. The operations indicated by the dotted arrows A2 and B2 can be carried out at the same time to increase the processing efficiency.

The transmission rate between the first data access unit 221 and the first memory unit 240 should be at least two times of that of the data transmission interfaces 225c and 235c. Thus, the first data access unit 221 can first store the image pixels of the first image (i.e., first execute the operation indicated by the arrow A2) and then the image pixels of the second image (i.e., execute the operation indicated by the arrow B2 after the operation indicated by the arrow A2 is finished).

Before writing image data into the first memory unit 240, the first task control unit 224 of the first (master) processor 220 configures corresponding storage addresses in the first memory unit 240 through the first data access unit 221 according to a predetermined 3D image format. In other words, the first (master) processor 220 writes a file header of the 3D image to a specific storage address in the first memory unit 240 and allocates storage addresses to notify the first data access unit 221 about the corresponding storage addresses for writing the right-eye image and the left-eye image, so that the operations indicated by arrows A2 and B2 can be accomplished.

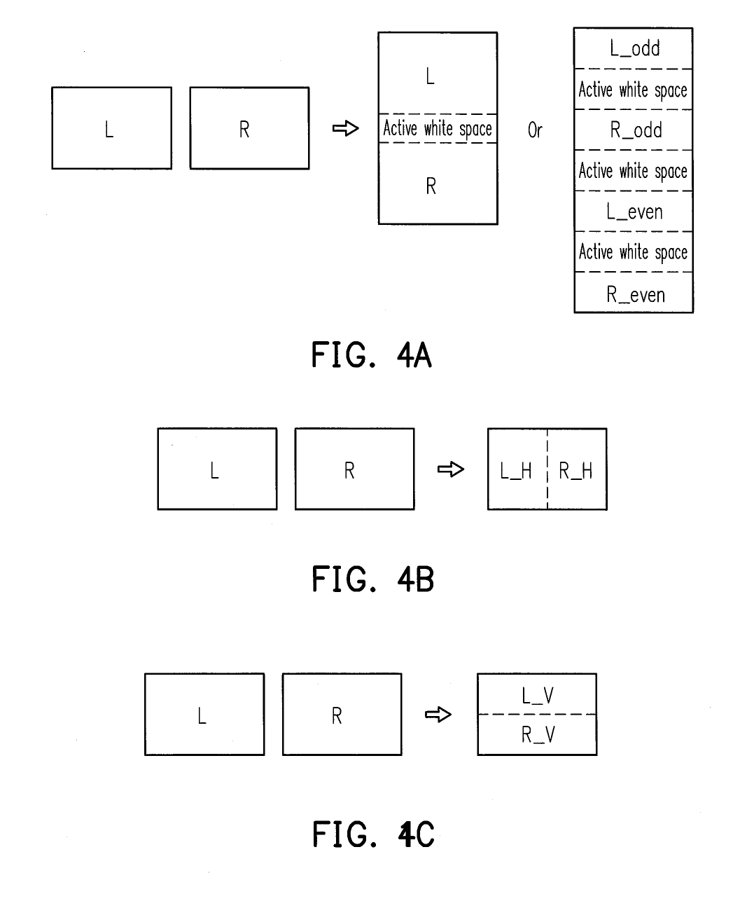

Below, implementation examples of aforementioned “3D image format” will be explained. FIGS. 4A-4C are diagrams of three currently used 3D image formats. To be specific, FIG. 4A, FIG. 4B, and FIG. 4C are respectively diagrams of memory storage blocks in the first memory unit 240 corresponding to three 3D image formats (a frame packing format, a side-by-side horizontal format, and a top-bottom format). The 2D images indicated with “L” are image pixels of the left-eye image captured and processed by the image sensor 210 in FIG. 3, and the 2D images indicated with “R” are image pixels of the right-eye image captured and processed by the image sensor 212 in FIG. 3.

Referring to both FIG. 3 and FIG. 4A, when the first (master) processor 220 integrates the left-eye image L and the right-eye image R according to the frame packing format, a first frame packing format is to store the complete left-eye image L into the memory block before the 3D image data, add an active white space with a plurality of white scan lines, and then store the complete right-eye image R into the memory block after the 3D image data, so as to generate a 3D image in the frame packing format.

Another frame packing format is to store odd number scan lines and even number scan lines of the left-eye image L respectively to corresponding storage addresses of 2D images L_odd and L_even (and similarly, to store odd number scan lines and even number scan lines of the right-eye image R to corresponding storage addresses of 2D images R_odd and R_even) and add an active white space with a plurality of white scan lines between every two images (as the rightmost arrangement shown in FIG. 4A), so as to generate a 3D image in the frame packing format.

As to the side-by-side horizontal format, as shown in FIG. 4B, the first data access unit 221 in FIG. 3 respectively discards half of the pixels on each scan line in the left-eye image L and the right-eye image R (for example, discards odd number image pixels or even number image pixels on each scan line), stores remaining 2D images L_H and R_H into the first memory unit 240 in FIG. 3, and generates a 3D image in the side-by-side horizontal format according to the arrangement as shown in FIG. 4B. As to the top-bottom format, as shown in FIG. 4C, the first (master) processor 220 in FIG. 3 respectively discards half of the scan lines in the left-eye image L and the right-eye image R (for example, discards odd number scan lines or even number scan lines), stores remaining 2D images L_V and R_V, and generates a 3D image in the top-bottom format according to the arrangement as shown in FIG. 4C.

As described above, the major difference between the first (master) processor 220 and the second (slave) processor 230 is that the first (master) processor 220 has the first data access unit 221 and the external transmission interface (the SDIO transmission interface 228 and/or the HDMI interface 329), which the second (slave) processor 230 does not have. Thus, the functions of the first (master) processor 220 and the second (slave) processor 230 can be respectively performed by using two same processors and disabling the data access unit of the second (slave) processor 230 and the external transmission interface. Or, the first (master) processor 220 and the second (slave) processor 230 may also be implemented with two different processors, and the first image processing unit 222 of the first (master) processor 220 and the second image processing unit 232 of the second (slave) processor 230 substantially generate the same image processing result.

After generating a 3D image in the first memory unit 240 as described above, the first (master) processor 220 instantly transmits the 3D image in the 3D image format to a display unit 160 through the HDMI interface 229 so as to provide a live view of the 3D image (as indicated by the arrow C1). Or, the first (master) processor 220 stores the 3D image into a portable storage unit 170 (for example, a secure digital (SD) card) through the SDIO transmission interface 228 (as indicated by the arrow C2), so as to complete 3D still image capturing or video clipping.

In other embodiments, the first memory unit 240 may be omitted and the 3D image generating device 200 may directly transmit the left-eye image and the right-eye image to the HMDI interface 229 and/or the SDIO transmission interface 228 according to aforementioned 3D image format and transmission timing, so that faster live view and still image storage can be achieved.

### Second Embodiment

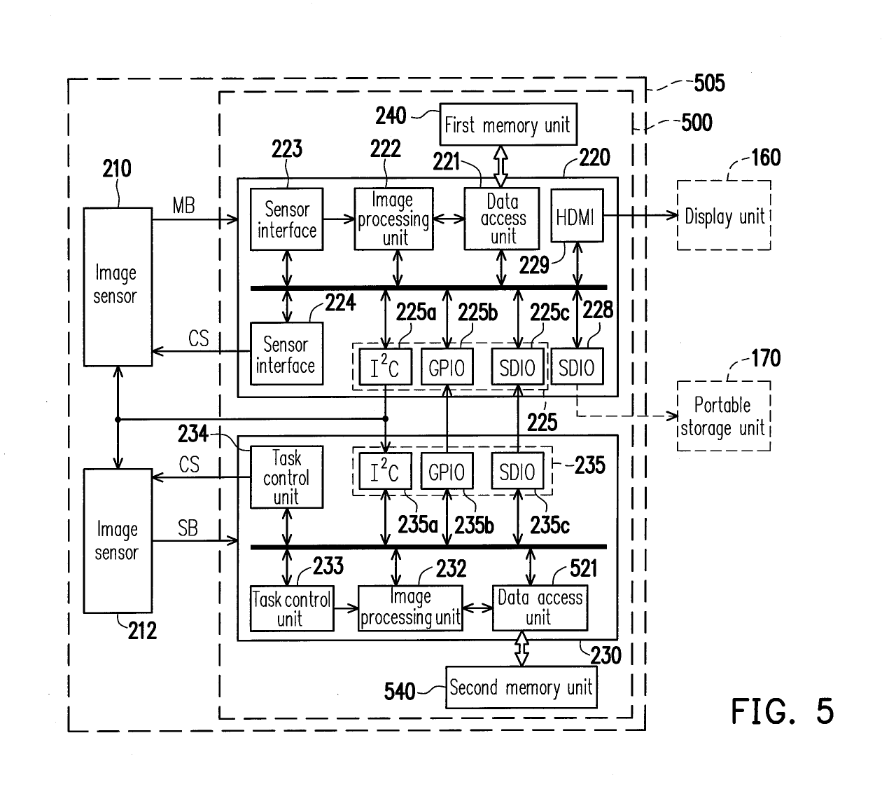

FIG. 5 is a function block diagram of a 3D image generating device 500 and a 3D image capturing apparatus 505 using the same according to the second embodiment of the invention. The second embodiment is similar to the first embodiment, and the difference between the two is that the 3D image generating device 500 further includes a second memory unit 540 and the second (slave) processor 230 further includes a second data access unit 521. The first data access unit 221 is coupled to the first memory unit 240 and configured to access the first memory unit 240. Similarly, the second data access unit 521 is coupled to the second memory unit 540 and configured to access the second memory unit 540. The second task control unit 234 also issues commands to the second data access unit 521 to coordinate and execute operations of the second (slave) processor 230.

Thereby, the 3D image generating device 500 can process 3D images having larger file sizes by using the two image processing units 220 and 230 and the memory units 240 and 540 thereof, so as to provide 3D image live view, high-resolution still image storage, or video clipping. Other components of the 3D image generating device 500 and the functions thereof are similar to those in the first embodiment therefore will not be described herein.

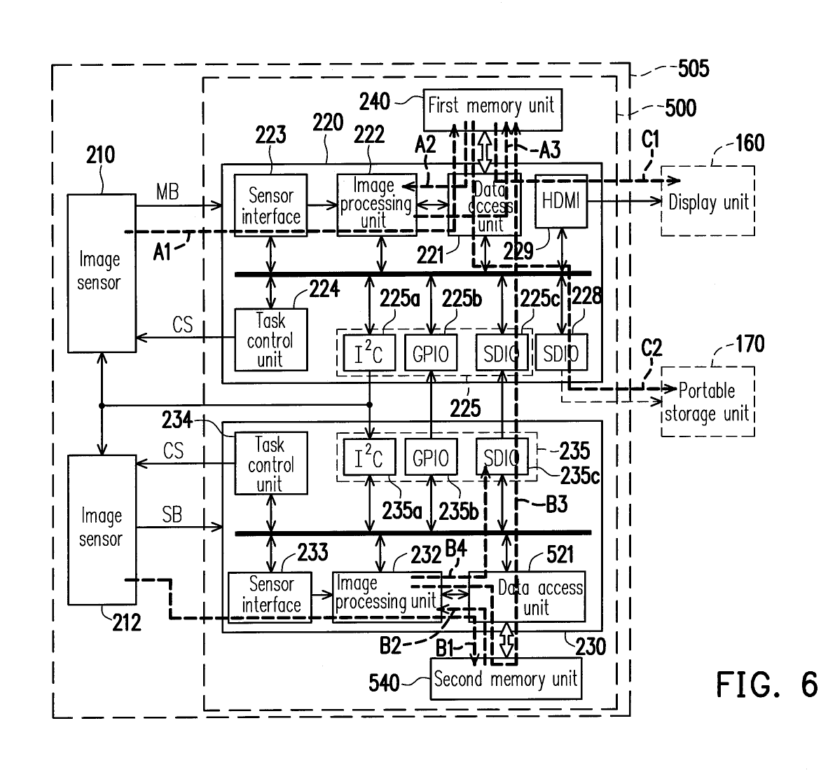

FIG. 6 is a diagram illustrating the processing of an image stream at the generation, live view, and storage of a 3D image according to the second embodiment of the invention. The image sensors 210 and 212 in the present embodiment are applicable to a system with higher resolution and higher image transmission rate, and because the real-time operation capability of the image sensors 210 and 212 exceeds that of the first image processing unit 222 and the second image processing unit 232, a buffer memory with sufficient capacity is required for temporarily storing the 2D images.

Thereby, as indicated by the dotted arrows A1 and B1, part or all of the pixel data in the left-eye image and the right-eye image of the to-be-processed images which are captured by the image sensors 210 and 212 and respectively represent a left human eye and a right human eye is respectively stored into the first memory unit 240 and the second memory unit 540 through the sensor interfaces 223 and 233. The size of aforementioned “part or all of the pixel data” can be adjusted according to the processing rates of the image processing units 230 and 232 so as to allow the performances of the image processing units 230 and 232 to reach their optimal states.

In FIG. 6, after the sensor interfaces 223 and 233 respectively receive part or all of the pixel data in the left-eye image and the right-eye image of the to-be-processed images captured by the image sensors 210 and 212, as indicated by the dotted arrows A1 and B1, the first image processing unit 222 and the second image processing unit 232 respectively perform one or more real-time pre-processings (for example, deduct a DC offset, multiply a digital gain, and perform a Gamma correction, etc) on the pixel data and write the pixel data into the first memory unit 240 and the second memory unit 540 respectively through the first data access unit 221 and the second data access unit 521.

In some embodiments, after the sensor interfaces 223 and 233 respectively receive part or all of the pixel data in the left-eye image and the right-eye image of the to-be-processed images captured by the image sensors 210 and 212 (as shown in FIG. 6), the first image processing unit 222 and the second image processing unit 232 may also be omitted (not shown in FIG. 6) by the operations indicated by the dotted arrows A1 and B1, so that no pre-processing is performed and the pixel data is directly written into the first memory unit 240 and the second memory unit 540 respectively through the first data access unit 221 and the second data access unit 521.

The sizes of the 2D images captured by the image sensors 210 and 212 and the image capturing rates of the image sensors 210 and 212 should be the same. Thus, when pixel data in the left-eye image and the right-eye image of the same size is respectively stored into the first memory unit 240 and the second memory unit 540 at the same time, the first image processing unit 222 and the second image processing unit 232 read the pixel data of the first image (the right-eye image) and the second image (the left-eye image) respectively through the first data access unit 221 and the second data access unit 521 and respectively generate a plurality of image pixels of the first image (the right-eye image) and the second image (the left-eye image) through image processing, as indicated by the dotted arrows A2 and B2.

After that, the first (master) processor 220 writes the image pixels to a corresponding storage address in the first memory unit 240 through the first data access unit 221 according to a predetermined 3D image format (as indicated by the dotted arrow A3). Meanwhile, as indicated by the dotted arrow B4, the image pixels of the second image processed by the second image processing unit 232 are transmitted to the first command/data transmission interface (the SIDO interface 225c) of the first (master) processor 220 through the second command/data transmission interface (the SIDO interface 235c) and then to the first data access unit 221 of the first (master) processor 220, and the image pixels of the second image are written to a corresponding storage address in the first memory unit 240 according to the predetermined 3D image format.

Additionally, the image pixels of the second image processed by the second image processing unit 232 are first temporarily stored into the second memory unit 540 through the second data access unit 521 (as indicated by the dotted arrow B3). Once a specific number of image pixels are accumulated, the image pixels are read by the second data access unit 521 and transmitted to the second command/data transmission interface (the SIDO interface 235c) and the first command/data transmission interface (the SIDO interface 225c) of the first (master) processor 220 and then to the first data access unit 221 of the first (master) processor 220, and the image pixels of the second image are written to a corresponding storage address in the first memory unit 240 according to a predetermined 3D image format.

Before the 3D image data is written into the first memory unit 240, the first task control unit 224 of the first (master) processor 220 configures corresponding storage addresses in the first memory unit 240 according to a predetermined 3D image format through the first data access unit 221. In other words, the first (master) processor 220 first writes a file header of the 3D image to a specific storage address in the first memory unit 240 and allocates the storage addresses to notify the first data access unit 221 about the corresponding storage addresses for writing the left-eye image and the right-eye image, so that the operations indicated by the arrows A3, B3, and B4 can be accomplished.

In the present embodiment, because two memory units 240 and 540 are respectively disposed in the processors 220 and 230 for buffering image data, the 3D image generating device 500 can be applied to the image sensors 210 and 212 with higher resolution and higher image transmission rate and store 3D images into the first memory unit 240.

Thereby, the first (master) processor 220 can transmit aforementioned 3D image to the display unit 160 through the HDMI interface 229 to provide live view of the 3D image (as indicated by the arrow C1). Or, the first (master) processor 220 can store the 3D image into the portable storage unit 170 through the SDIO transmission interface 228 (as indicated by the arrow C2), so as to accomplish 3D still image capturing or video clipping.

In other embodiments, it may also be assumed that the image sensors 210 and 212 capture 2D images of lower resolution or receive to-be-processed images through sensor interfaces with lower transmission rate. In this case, the control procedure illustrated in FIG. 3 is also applicable to the second embodiment of the invention. However, the implementation details will not be described herein.

### Third Embodiment

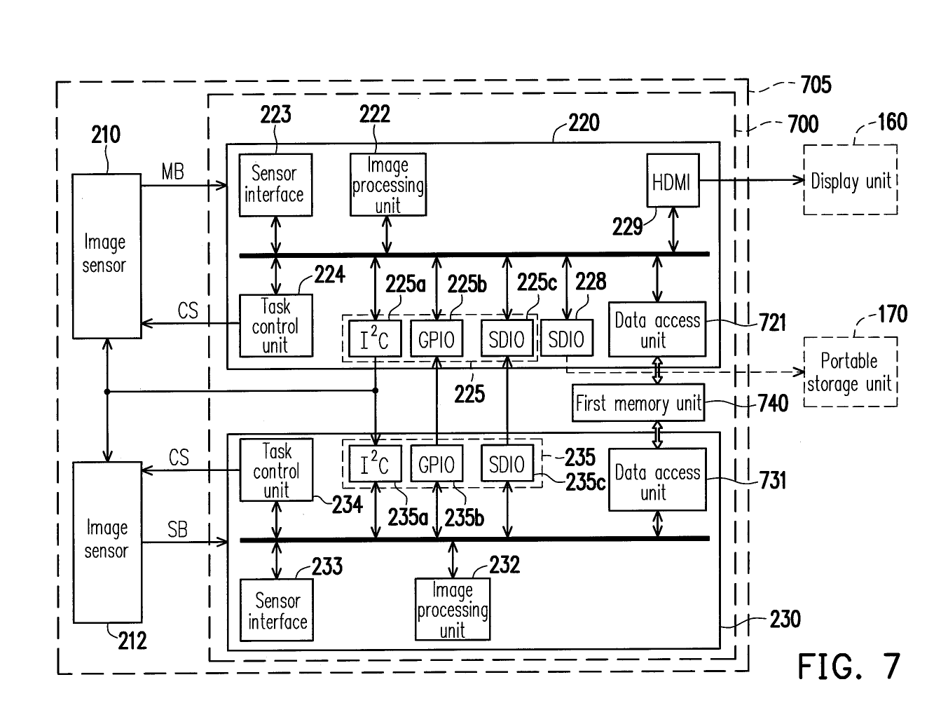

FIG. 7 is a function block diagram of a 3D image generating device 700 and a 3D image capturing apparatus 705 using the same according to the third embodiment of the invention. The third embodiment is similar to the first and the second embodiment described above, and the difference between the third embodiment and foregoing two embodiments is that the first (master) processor 220 and the second (slave) processor 230 in the 3D image generating device 700 respectively include a first data access unit 721 and a second data access unit 731. The first data access unit 721 and the second data access unit 731 are both coupled to the first memory unit 740 respectively through a first access bus and a second access bus. Namely, the first memory unit 740 is a dual port memory unit, and which includes at least a first access bus (coupled to the first data access unit 721) and a second access bus (coupled to the second data access unit 731) so that it can be accessed by two processors at the same time. Contrarily, the memory units 240 and 540 in the first and the second embodiment are single port memory units.

Thereby, the 3D image generating device 700 writes pixel data of a left-eye image and a right-eye image to corresponding storage addresses in the first memory unit 740 at the same time according to a 3D image format through the data access units 721 and 731 and the dual port memory unit 740. Thus, the 3D image generating device 700 can directly generate the desired 3D image in the first memory unit 740, so as to accomplish still image storage or video clipping of the 3D image. In addition, various components of the first (master) processor 220 and the second (slave) processor 230 are similar to those in the first embodiment therefore will not be described herein.

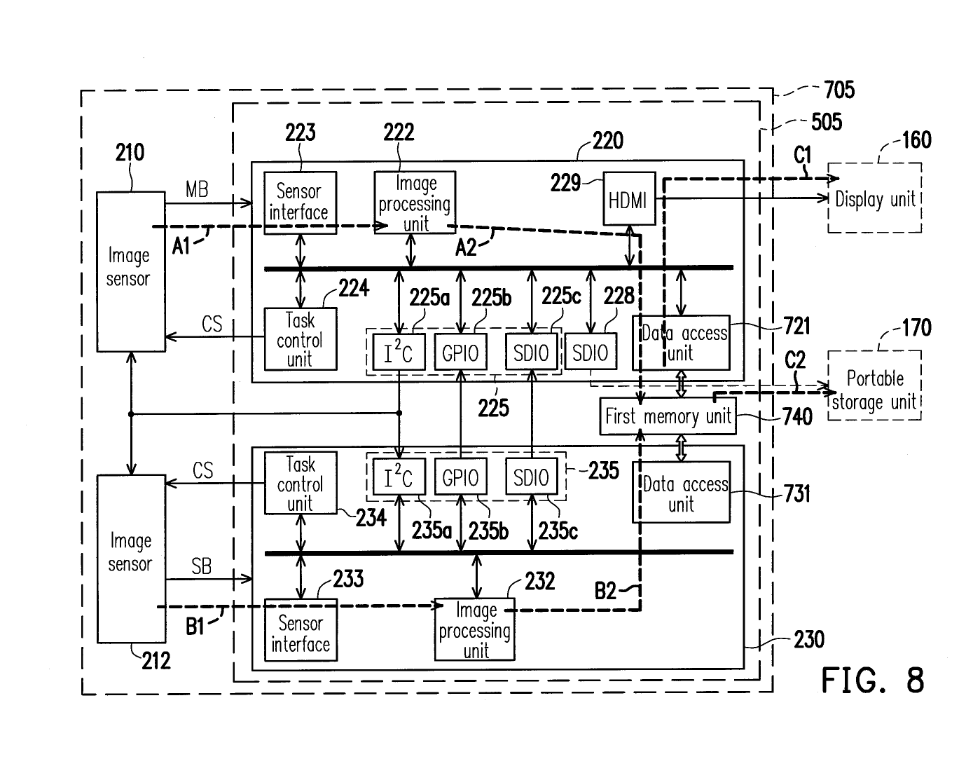

FIG. 8 is a diagram illustrating the processing of an image stream at the generation, live view, and storage of a 3D image according to the third embodiment of the invention. In the present embodiment, the image sensors 210 and 212 have higher resolution and image transmission rate, and the real-time operation capability thereof exceed that of the first image processing unit 222 and the second image processing unit 232. Thus, a buffer memory with sufficient capacity is required for temporarily storing the 2D images.

As indicated by the dotted arrows A1 and B1, part or all of the pixel data in the left-eye image and the right-eye image of the to-be-processed images which are captured by the image sensors 210 and 212 and respectively represent a left human eye and a right human eye is respectively stored into the first memory unit 740 through the sensor interfaces 223 and 233. The size of aforementioned “part or all of the pixel data” can be adjusted according to the processing rates of the image processing units 230 and 232 so as to allow the performances of the image processing units 230 and 232 to reach their optimal states.

In FIG. 8, after the sensor interfaces 223 and 233 respectively receive part or all of the pixel data in the left-eye image and the right-eye image of the to-be-processed images captured by the image sensors 210 and 212, as indicated by the dotted arrows A1 and B1, the first image processing unit 222 and the second image processing unit 232 respectively perform one or more real-time pre-processings (for example, deduct a DC offset, multiply a digital gain, and perform a Gamma correction, etc) on the pixel data and write the pixel data into the first memory unit 740 respectively through the first data access unit 721 and the second data access unit 731.

In some embodiments, after the sensor interfaces 223 and 233 respectively receive part or all of the pixel data in the left-eye image and the right-eye image of the to-be-processed images captured by the image sensors 210 and 212 (as shown in FIG. 8), the first image processing unit 222 and the second image processing unit 232 may also be omitted (not shown in FIG. 8) by the operations indicated by the dotted arrows A1 and B1, so that no pre-processing is performed and the pixel data is directly written into the first memory unit 740 respectively through the first data access unit 721 and the second data access unit 731.

The sizes of the 2D images captured by the image sensors 210 and 212 and the image capturing rates of the image sensors 210 and 212 should be the same. Thus, when pixel data in the left-eye image and the right-eye image of the same size is respectively stored into the first memory unit 740 at the same time, the first image processing unit 222 and the second image processing unit 232 read the pixel data of the first image (the right-eye image) and the second image (the left-eye image) respectively through the first data access unit 721 and the second data access unit 731 and respectively generate a plurality of image pixels of the first image (the right-eye image) and the second image (the left-eye image) through image processing, as indicated by the dotted arrows A2 and B2.

After that, the first (master) processor 220 writes the image pixels of the first image (the right-eye image) to a corresponding storage address in the first memory unit 740 through the first data access unit 721 according to a predetermined 3D image format (as indicated by the dotted arrow A3). Meanwhile, as indicated by the dotted arrow B3, the second (slave) processor 230 writes the image pixels of the second image (the left-eye image) to a corresponding storage address in the first memory unit 740 through the second data access unit 731 according to the predetermined 3D image format.

Before the 3D image data is written into the dual port memory unit 740, the first task control unit 224 of the first (master) processor 220 configures corresponding storage addresses in the dual port memory unit 740 through the first data access unit 221 according to a predetermined 3D image format. In other words, the first (master) processor 220 writes a file header of the 3D image to a specific storage address in the dual port memory unit 740 and then allocates the storage addresses to notify the first data access unit 221 about the corresponding storage addresses for writing the right-eye image and the left-eye image, so that the operations indicated by the arrows A3 and B3 can be accomplished.

In the present embodiment, because a dual port memory unit 740 is disposed for buffering data for the processors 220 and 230, the 3D image generating device 700 can be applied to the image sensors 210 and 212 having higher resolution and image transmission rate and store 3D images into the first memory unit 740.

Thereby, the first (master) processor 220 transmits the 3D image to the display unit 160 through the HDMI interface 229 to provide a live view (as indicated by the arrow C1). The first (master) processor 220 may also store the 3D image into the portable storage unit 170 through the SDIO transmission interface 228 (as indicated by the arrow C2), so as to accomplish 3D still image capturing or video clipping.

In a 3D image generating device provided by one of foregoing embodiments, a left-eye 2D image and a right-eye 2D image are respectively processed by using two image processors 220 and 230, and the two 2D images are integrated into a 3D image in real time through the first (master) processor 220 or two data access units according to a predetermined 3D image format. Thereby, the 3D image generating device does not need a buffer memory with large capacity. Accordingly, the 3D image generating device offers low cost, good image processing efficiency, and increased 3D image integration rate.

In addition, because the second (slave) processor 230 needs not to integrate the 3D image, it can be implemented by using a device having lower operation performance than the first (master) processor 220. On the other hand, the second (slave) processor 230 does not need any external transmission interface (for example, the HDMI interface 229 or the SDIO transmission interface 228). Thus, a 3D image generating device in the invention and a 3D image capturing apparatus using the same can offer low cost and good image processing efficiency through the design described above.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A three-dimensional (3D) image generating device, comprising:
a first memory unit, storing a 3D image;
a first processor, comprising:
a first image processing unit, having an input terminal for receiving a plurality of pixel data of a to-be-processed image representing a first human eye, and generating a plurality of image pixels of a first image through image processing;
a data access unit, coupled to the first image processing unit and the first memory unit, receiving the image pixels of the first image from the first image processing unit, and writing the image pixels of the first image to a corresponding storage address in the first memory unit according to a predetermined 3D image format;
a first command/data transmission interface, coupled to the data access unit; and
a first task control unit, issuing commands and parameters to the first image processing unit, the data access unit, and the first command/data transmission interface to coordinate and execute operations of the first processor; and
a second processor, coupled to the first processor, comprising:
a second image processing unit, having an input terminal for receiving a plurality of pixel data of an to-be-processed image representing a second human eye, and generating a plurality of image pixels of a second image through image processing;
a second command/data transmission interface, coupled to the second image processing unit and the first command/data transmission interface of the first processor, wherein the first command/data transmission interface and the second command/data transmission interface transmit commands and data for the second processor and the first processor; and
a second task control unit, communicating with the first processor through the second command/data transmission interface, and issuing commands to the second image processing unit, the data access unit, and the second command/data transmission interface to coordinate and execute operations of the second processor;
wherein the image pixels of the second image processed by the second image processing unit are transmitted to the first command/data transmission interface of the first processor through the second command/data transmission interface and then to the data access unit of the first processor, and the image pixels of the second image are written to a corresponding storage address in the first memory unit according to the predetermined 3D image format, so as to generate the 3D image.

2. The 3D image generating device according to claim 1, wherein the first image processing unit and the second image processing unit further respectively comprise a compression unit, and the compression units respectively compress and output the processed first image and the processed second image.

3. The 3D image generating device according to claim 1, wherein the first command/data transmission interface is implemented with respectively a first command transmission interface and a first data transmission interface, and the second command/data transmission interface is implemented with respectively a second command transmission interface and a second data transmission interface,
wherein the first command transmission interface and the second command transmission interface are coupled with each other to allow the first processor and the second processor to communicate with each other, and the first data transmission interface and the second data transmission interface are coupled with each other to transmit image data between the first processor and the second processor.

4. The 3D image generating device according to claim 1 further comprising:
a first image sensor, coupled to the first processor, capturing the two-dimensional (2D) to-be-processed image representing the first human eye and outputting the 2D to-be-processed image to the first processor; and
a second image sensor, coupled to the second image processing unit, capturing the 2D to-be-processed image representing the second human eye and outputting the 2D to-be-processed image to the second processor,
wherein the first image sensor and the second image sensor operate according to commands and parameters received from the first processor.

5. The 3D image generating device according to claim 4, wherein commands and parameters issued by the first processor are first output to the second processor and then transmitted to the second image sensor through the second processor to control operations of the second image sensor.

6. The 3D image generating device according to claim 1, wherein the first processor and the second processor are implemented with two same processors, and the two same processors respectively perform functions of the first processor and the second processor.

7. The 3D image generating device according to claim 1, wherein the first processor and the second processor are implemented with two different processors, and the first image processing unit of the first processor and the second image processing unit of the second processor substantially generate same image processing results.

8. A 3D image generating device, comprising:
a first memory unit, storing at least a plurality of or all pixel data of a first image representing a first human eye, and storing a 3D image;
a first processor, comprising:
a first data access unit, coupled to the first memory unit and configured to access the first memory unit;
a first image processing unit, coupled to the first data access unit, reading the pixel data of the first image through the first data access unit, generating a plurality of image pixels of the first image through image processing, and writing the image pixels to a corresponding storage address in the first memory unit according to a predetermined 3D image format;
a first command/data transmission interface, coupled to the first data access unit; and
a first task control unit, issuing commands to the first image processing unit, the first data access unit, and the first command/data transmission interface to coordinate and execute operations of the first processor; and
a second memory unit, storing at least a plurality of or all pixel data of a second image representing a second human eye;
a second processor, comprising:
a second data access unit, coupled to the second memory unit and configured to access the second memory unit;
a second image processing unit, coupled to the second data access unit, reading the pixel data of the second image through the second data access unit, and generating a plurality of image pixels of the second image through image processing;
a second command/data transmission interface, coupled to the second image processing unit and the first command/data transmission interface of the first processor, wherein the first command/data transmission interface and the second command/data transmission interface transmit data for the second processor and the first processor; and
a second task control unit, communicating with the first processor through the second command/data transmission interface, and issuing commands to the second image processing unit, the second data access unit, and the second command/data transmission interface to coordinate and execute operations of the second processor;
wherein the image pixels of the second image processed by the second image processing unit are transmitted to the first command/data transmission interface of the first processor through the second command/data transmission interface and then to the first data access unit of the first processor, and the image pixels of the second image are written to a corresponding storage address in the first memory unit according to the predetermined 3D image format.

9. The 3D image generating device according to claim 8, wherein the first image processing unit and the second image processing unit further respectively comprise a compression unit, and the compression units respectively compress and output the processed first image and the processed second image.

10. The 3D image generating device according to claim 8, wherein the first command/data transmission interface is implemented with respectively a first command transmission interface and a first data transmission interface, and the second command/data transmission interface is implemented with respectively a second command transmission interface and a second data transmission interface,
wherein the first command transmission interface and the second command transmission interface are coupled with each other to allow the first processor and the second processor to communicate with each other, and the first data transmission interface and the second data transmission interface are coupled with each other to transmit image data between the first processor and the second processor.

11. The 3D image generating device according to claim 8 further comprising:
a first image sensor, coupled to the first processor, capturing the 2D to-be-processed image representing the first human eye and outputting the 2D to-be-processed image to the first processor, and writing the 2D to-be-processed image into the first memory unit through the first data access unit of the first processor; and
a second image sensor, coupled to the second processor, capturing the 2D to-be-processed image representing the second human eye and outputting the 2D to-be-processed image to the second processor, and writing the 2D to-be-processed image into the second memory unit through the second data access unit of the second processor,
wherein the first image sensor and the second image sensor operate according to commands and parameters received from the first processor.

12. The 3D image generating device according to claim 11, wherein commands and parameters issued by the first processor are first output to the second processor and then transmitted to the second image sensor through the second processor to control operations of the second image sensor.

13. The 3D image generating device according to claim 8, wherein the first processor and the second processor are implemented with two same processors, and the two same processors respectively perform functions of the first processor and the second processor.

14. The 3D image generating device according to claim 8, wherein the first processor and the second processor are implemented with two different processors, and the first image processing unit of the first processor and the second image processing unit of the second processor substantially generate same image processing results.

15. A 3D image generating device, comprising:
a first memory unit, at least comprising a first access bus and a second access bus, and storing a 3D image;
a first processor, comprising:
a first image processing unit, having an input terminal for receiving a plurality of pixel data of an to-be-processed image representing a first human eye, and generating a plurality of image pixels of a first image through image processing;
a first data access unit, coupled to the first image processing unit and the first access bus of the first memory unit, receiving the image pixels of the first image from the first image processing unit, and writing the image pixels of the first image to a corresponding storage address in the first memory unit according to a predetermined 3D image format;
a first command/data transmission interface, coupled to the first data access unit; and
a first task control unit, issuing commands and parameters to the first image processing unit, the first data access unit, and the first command/data transmission interface to coordinate and execute operations of the first processor; and
a second processor, coupled to the first processor, the second processor comprising:
a second image processing unit, having an input terminal for receiving a plurality of pixel data of an to-be-processed image representing a second human eye, and generating a plurality of image pixels of a second image through image processing;
a second data access unit, coupled to the second image processing unit and the second access bus of the first memory unit;
a second command/data transmission interface, coupled to the second image processing unit and the first command/data transmission interface of the first processor, wherein the first command/data transmission interface and the second command/data transmission interface transmit commands and data for the second processor and the first processor; and
a second task control unit, communicating with the first processor through the second command/data transmission interface, and issuing commands to the second image processing unit, the second data access unit, and the second command/data transmission interface to coordinate and execute operations of the second processor;
wherein the second data access unit receives the image pixels of the second image processed by the second image processing unit and writes the image pixels of the second image to a corresponding storage address in the first memory unit according to the predetermined 3D image format, so as to generate the 3D image.

16. The 3D image generating device according to claim 15, wherein the first image processing unit and the second image processing unit further respectively comprise a compression unit, and the compression units respectively compress and output the processed first image and the processed second image.

17. The 3D image generating device according to claim 15, wherein the first command/data transmission interface is implemented with respectively a first command transmission interface and a first data transmission interface, and the second command/data transmission interface is implemented with respectively a second command transmission interface and a second data transmission interface,
wherein the first command transmission interface and the second command transmission interface are coupled with each other to allow the first processor and the second processor to communicate with each other, and the first data transmission interface and the second data transmission interface are coupled with each other to transmit image data between the first processor and the second processor.

18. The 3D image generating device according to claim 15 further comprising:
a first image sensor, coupled to the first processor, capturing the two-dimensional (2D) to-be-processed image representing the first human eye and outputting the 2D to-be-processed image to the first processor; and
a second image sensor, coupled to the second image processing unit, capturing the 2D to-be-processed image representing the second human eye and outputting the 2D to-be-processed image to the second processor,
wherein the first image sensor and the second image sensor operate according to commands and parameters received from the first processor.

19. The 3D image generating device according to claim 18, wherein commands and parameters issued by the first processor are first output to the second processor and then transmitted to the second image sensor through the second processor to control operations of the second image sensor.

20. The 3D image generating device according to claim 15, wherein the first processor and the second processor are implemented with two same processors, and the two same processors respectively perform functions of the first processor and the second processor.

21. The 3D image generating device according to claim 15, wherein the first processor and the second processor are implemented with two different processors, and the first image processing unit of the first processor and the second image processing unit of the second processor substantially generate same image processing results.
